(19) United States
(12) Patent Application Publication
(10) Pub. No.: US 2026/0282067 A1
(43) Pub. Date: Sep. 17, 2026

(54) DATA TRANSMISSION METHOD AND APPARATUS, DEVICE, AND STORAGE MEDIUM

(71) Applicant: Tencent Technology (Shenzhen) Company Limited, Shenzhen (CN)

(72) Inventor: Yuan YAN, Shenzhen (CN)

(21) Appl. No.: 19/667,485

(22) Filed: May 4, 2026

Related U.S. Application Data
(63) Continuation of application No. PCT/CN2025/082046, filed on Mar. 12, 2025.

(30) Foreign Application Priority Data
Mar. 26, 2024 (CN) 202410362454.7

(51) Int. Cl. H04W 72/542; H04W 24/08; H04W 48/18

(52) U.S. Cl. CPC H04W 72/542; H04W 24/08; H04W 48/18

(57) ABSTRACT

This application discloses a data transmission method performed by a computer device acting as a terminal. In the solution provided by this application, the terminal determines the signal strength of networks currently accessible to the terminal by obtaining a first network quality parameter value of a first network and a second network quality parameter value of a second network. The terminal then selects a network having the strongest signal strength as a primary network while other networks serve as backup networks. After the primary network provides the terminal with the network bandwidth required for data transmission and operates stably for a first duration, the terminal disconnects itself from the backup networks. In this way, redundant network connections are reduced, thereby reducing power consumption of the terminal and improving the endurance of the terminal.

### CROSS-REFERENCE TO RELATED APPLICATIONS

This application is a continuation application of PCT Patent Application No. PCT/CN2025/082046, entitled “DATA TRANSMISSION METHOD AND APPARATUS, DEVICE, AND STORAGE MEDIUM” filed on Mar. 12, 2025, which claims priority to Chinese Patent Application No. 2024103624547, entitled "DATA TRANSMISSION METHOD AND APPARATUS, DEVICE, AND STORAGE MEDIUM" filed with the China National Intellectual Property Administration on Mar. 26, 2024, all of which are incorporated herein by reference in their entirety.

### FIELD OF THE TECHNOLOGY

This application relates to the field of communications, and to a data transmission technology.

### BACKGROUND OF THE DISCLOSURE

With the continuous development of technology, an increasing number of technologies rely on wireless networks for implementation, and the implementation effect of some technologies is highly correlated with network stability and capacity. For example, Internet live streaming requires stable network bandwidth. Insufficient network bandwidth or jitter may lead to a decrease in video bit rate or freezing, which in turn causes picture freezing in Internet live streaming and significantly affects user experience.

To resolve this problem, a plurality of cellular networks may be used in a bundled manner. In an Internet live streaming scenario, a cellular terminal is integrated with two to three 5G modules, and universal subscriber identity module (USIM) cards of different operators are inserted into different 5G modules, to improve the network performance stability of the cellular terminal in a redundant transmission or aggregated transmission manner.

However, integrating a plurality of 5G modules into a cellular terminal, whether in a redundant transmission manner or an aggregated transmission manner, will result in high power consumption of the cellular terminal. High power consumption will directly lead to heating of the cellular terminal, thereby causing performance degradation and poor endurance.

### SUMMARY

Embodiments of this application provide a data transmission method and apparatus, a device, and a storage medium, to reduce power consumption of a terminal with a plurality of communication modules, to improve the performance and endurance of the terminal.

In view of this, a first aspect of this application provides a data transmission method, performed by a computer device acting as a terminal. The method includes:

obtaining, by the terminal, a first network quality parameter value of a first network and a second network quality parameter value of a second network;

when the first network quality parameter value is greater than the second network quality parameter value, determining, by the terminal, the first network as a primary network and the second network as a backup network;

obtaining, by the terminal, a first transmission rate, the first transmission rate being an average transmission rate of data transmission performed by the terminal via the primary network within a first period; and

when the first transmission rate satisfies a reference condition, disconnecting, by the terminal, itself from the backup network after a first duration.

A second aspect of this application provides a computer device acting as a terminal, including a memory, a processor, and a bus system.

The memory is configured to store a program.

The processor is configured to execute the program in the memory and perform the data transmission method according to the foregoing aspects based on instructions in program code.

The bus system is configured to connect the memory and the processor, to cause the memory to communicate with the processor.

A third aspect of this application provides a non-transitory computer-readable storage medium. The computer-readable storage medium has instructions stored therein. The instructions, when executed by a processor of a computer device acting as a terminal, cause the terminal to perform the data transmission method in the foregoing aspects.

It can be seen from the foregoing technical solutions that the embodiments of this application have the following advantages:

In the solution provided by the embodiments of this application, the terminal determines the signal strength of networks currently accessible to the terminal by obtaining a first network quality parameter value and a second network quality parameter value. The first network quality parameter value is obtained by measuring a first data transmission performed by the terminal via a first network. The second network quality parameter value is obtained by measuring a second data transmission performed by the terminal via a second network. In addition, the terminal then selects a network having the strongest signal strength as a primary network while other networks serve as backup networks. After the primary network provides the terminal with network bandwidth required for data transmission and operates stably for a first duration, the terminal disconnects itself from the backup networks. In this way, redundant network connections are reduced, thereby reducing power consumption of the terminal and improving the endurance of the terminal.

### BRIEF DESCRIPTION OF THE DRAWINGS

FIG. 1 is a schematic diagram of aggregate transmission of a multi-network terminal according to an embodiment of this application;

FIG. 2 is a schematic architectural diagram of a communication system according to an embodiment of this application;

FIG. 3 is a schematic flowchart of a data transmission method according to an embodiment of this application;

FIG. 4 is another schematic flowchart of a data transmission method according to an embodiment of this application;

FIG. 5 is another schematic flowchart of a data transmission method according to an embodiment of this application;

FIG. 6 is another schematic flowchart of a data transmission method according to an embodiment of this application;

FIG. 7 is another schematic flowchart of a data transmission method according to an embodiment of this application;

FIG. 8 is another schematic flowchart of a data transmission method according to an embodiment of this application;

FIG. 9 is a schematic diagram of a structure of a data transmission apparatus according to an embodiment of this application; and

FIG. 10 is a schematic diagram of a structure of a terminal according to an embodiment of this application.

### DESCRIPTION OF EMBODIMENTS

The terms such as "first", "second", "third", and "fourth" (if any) in the specification and claims of this application and in the accompanying drawings are used for distinguishing similar objects and not necessarily used for describing any particular order or sequence. Data used in this way is exchangeable in a proper case, so that the embodiments of this application described herein can be implemented in an order different from the order shown or described herein. In addition, the terms "include", "corresponding to" and any other variants are intended to cover the non-exclusive inclusion. For example, a process, method, system, product, or device that includes a series of operations or units is not necessarily limited to those expressly listed operations or units, but may include other operations or units not expressly listed or inherent to such a process, method, product, or device.

In the embodiment of this application, the term "module" or "unit" refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or unit.

In the related technology, a plurality of cellular networks may be used in a bundled manner to ensure stable network performance of a cellular terminal. Specifically, the cellular terminal is integrated with two to three 5G modules, and USIM cards of different operators may be inserted into different 5G modules, to improve the network performance stability of the cellular terminal in a redundant transmission or aggregated transmission manner.

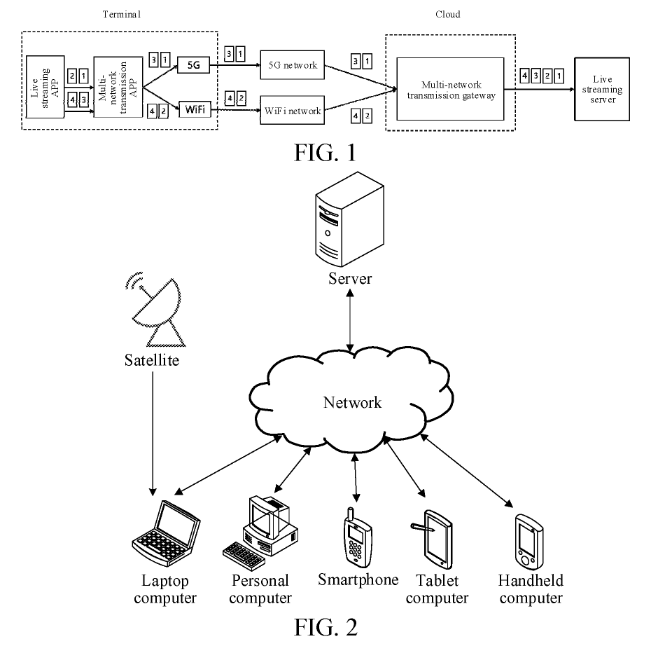

In the aggregated transmission manner, different data packets of a service are allocated to different networks for transmission according to network quality of different network links. Refer to FIG. 1, which is a schematic diagram of aggregate transmission of a multi-network terminal in the related technology.

As can be seen from FIG. 1, a live streaming APP divides a live streaming data stream into a plurality of data packets (data packet 1, data packet 2, data packet 3, and data packet 4). A multi-network transmission APP performs transmission allocation on the plurality of data packets. For example, the multi-network transmission APP allocates data packet 1 and data packet 3 to a first network (5G) for transmission, and allocates data packet 2 and data packet 4 to a second network (WiFi) for transmission. A multi-network transmission gateway aggregates the plurality of data packets (data packet 1, data packet 2, data packet 3, and data packet 4) at the cloud, restores to the original live streaming data stream, and then transmits the original live streaming data stream to a live streaming server for subsequent processing by the live streaming server.

In the aggregated transmission solution, although the capacity of two networks may be fully utilized to provide a larger network bandwidth for services, the situation where the capacity of both networks needs to be occupied does not persist during data transmission. Therefore, redundant network connections may occur, which causes higher power consumption of the terminal, and further leads to heating of the terminal, resulting in performance reduction and poor endurance.

To resolve the foregoing problems, this application proposes the following solution: when at least two USIM cards are provided in a terminal, the signal strength of a network corresponding to each USIM card is obtained, the USIM card with the strongest network signal is selected as a primary USIM card, and the remaining USIM cards are used as backup USIM cards. After the primary USIM card may provide network bandwidth meeting service requirements and operates in a stable state for a period, the terminal is disconnected from the networks corresponding to the backup USIM cards. While ensuring normal data transmission of the terminal, redundant network connections are reduced, thereby reducing power consumption of the terminal and improving the performance and endurance of the terminal.

The method provided by this application is applied to a communication system as shown in FIG. 2. Referring to FIG. 2, FIG. 2 is a schematic architecture diagram of a communication system according to an embodiment of this application. As shown in the figure, the communication system includes a server, a terminal, and a satellite, and a client is deployed on the terminal. The client may run on the terminal in the form of a browser, or in the form of a standalone application (APP), etc. The specific implementation form of the client is not limited herein. The server involved in this application may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and big data and artificial intelligence platforms. The terminal may be a smartphone, a tablet computer, a laptop computer, a handheld computer, a personal computer, a smart television, a smart watch, a vehicle-mounted device, a wearable device, etc., but is not limited thereto. The terminal and the server may be connected directly or indirectly in a wired communication manner or a wireless communication manner. This is not limited in this application. A quantity of servers and a quantity of terminals are not limited either. The solution provided by this application may be implemented independently by the terminal, independently by the server, or cooperatively by the terminal and the server. This is not specifically limited in this application.

When the method provided by this application is implemented by a computer device acting as a terminal, the terminal is configured to perform the following operations:

obtaining a first network quality parameter value and a second network quality parameter value, the first network quality parameter value being obtained by measuring a first data transmission performed by a terminal via a first network, and the second network quality parameter value being obtained by measuring a second data transmission performed by the terminal via a second network;

determining, when the first network quality parameter value is greater than the second network quality parameter value, the first network as a primary network and the second network as a backup network;

obtaining a first transmission rate, the first transmission rate being a transmission rate of data transmission performed by the terminal via the first network and/or the second network within a first period; and

when the first transmission rate satisfies a reference condition according to a transmission rate of data transmission performed by the terminal via the primary network, disconnecting the terminal from the backup network after a first duration. In some implementations, the first duration is longer than the first period and the first period may be part of the first duration.

Since this application involves some technical terms, the technical terms are first described below.

Quick user datagram protocol (UDP) Internet connection (QUIC): QUIC uses a UDP, creates a connection between two endpoints, and supports connection multiplexing. QUIC can provide network security protection equivalent to that of a socket secure layer (SSL)/transport layer security (TLS), reduce latency in data transmission and connection establishment, control bandwidth in both directions to avoid network congestion, and improve a web page transmission speed.

UDP: Like a transmission control protocol (TCP), UDP is configured for processing data packets. In an open system interconnection (OSI) model, both the protocols are located at a transport layer, above an IP. UDP is a connectionless transport layer protocol in the OSI model, and is mainly configured for packet transmissions that are not required to be reached sequentially. The checking and sorting of the packet transmissions are performed by an application layer, and simple and unreliable transaction-oriented information delivery services are provided. UDP is essentially an interface between the IP and an upper-layer protocol. UDP is applicable to a plurality of applications running on the same device via different ports.

Multi-path QUIC (MP-QUIC) is a mainstream multi-network basic framework in the industry. Basic functions such as packet encapsulation, packet loss recovery, buffer management, and multi-path management are provided. MP-QUIC is a multi-path version of single-path QUIC. QUIC is mainly designed to resolve problems encountered by TCP in practical use, such as head-of-line blocking, low congestion control efficiency, disconnection caused by IP/port (PORT) changes, three-way handshake overhead, and low out-of-band control efficiency.

Quality of service (QoS) refers to the capability of a network to use various basic technologies to provide better service for specified network communications, and is a network security mechanism and a technology for resolving problems such as network delay and congestion.

A QoS class identify (QCI) is configured for measuring a specific forwarding behavior (e.g., a packet loss rate or a packet delay budget) provided for a standard delay formation (SDF) packet, is applied to both guarantee bit rate (GBR) and non-GBR forwarding, and is configured for specifying a bearer-level packet forwarding manner defined within an access node (e.g., a scheduling weight, an admission threshold, a queue management threshold, a link-layer protocol configuration, etc.).

GBR means that channel resources used by a user in communication have a guaranteed minimum transmission rate. To be specific, a guaranteed minimum transmission rate is provided when the user uses the channel resources. The minimum transmission rate of the channel resources used by the user will not be lower than a value within a period. GBR bearers are mainly applied to a real-time APP, such as voice communication and video conferencing. Such applications require a guaranteed minimum transmission rate to ensure the quality of the real-time APP.

Non-GBR means that channel resources used by a user in communication do not have a guaranteed minimum transmission rate. To be specific, a guaranteed minimum transmission rate is not provided when the user uses the channel resources. There is no explicit lower limit for the minimum transmission rate of the channel resources used by the user within a period. Non-GBR is mainly applied to a non-real-time APP, such as file transmission and database query.

Based on the above description, this application describes a situation where a terminal is provided with two USIM cards and the terminal accesses a first network and a second network via the two USIM cards respectively.

The solution provided by this application may be applied to a situation where the terminal has two or more USIM cards. In practical applications, adjustments may be made according to specific conditions. This is not limited herein.

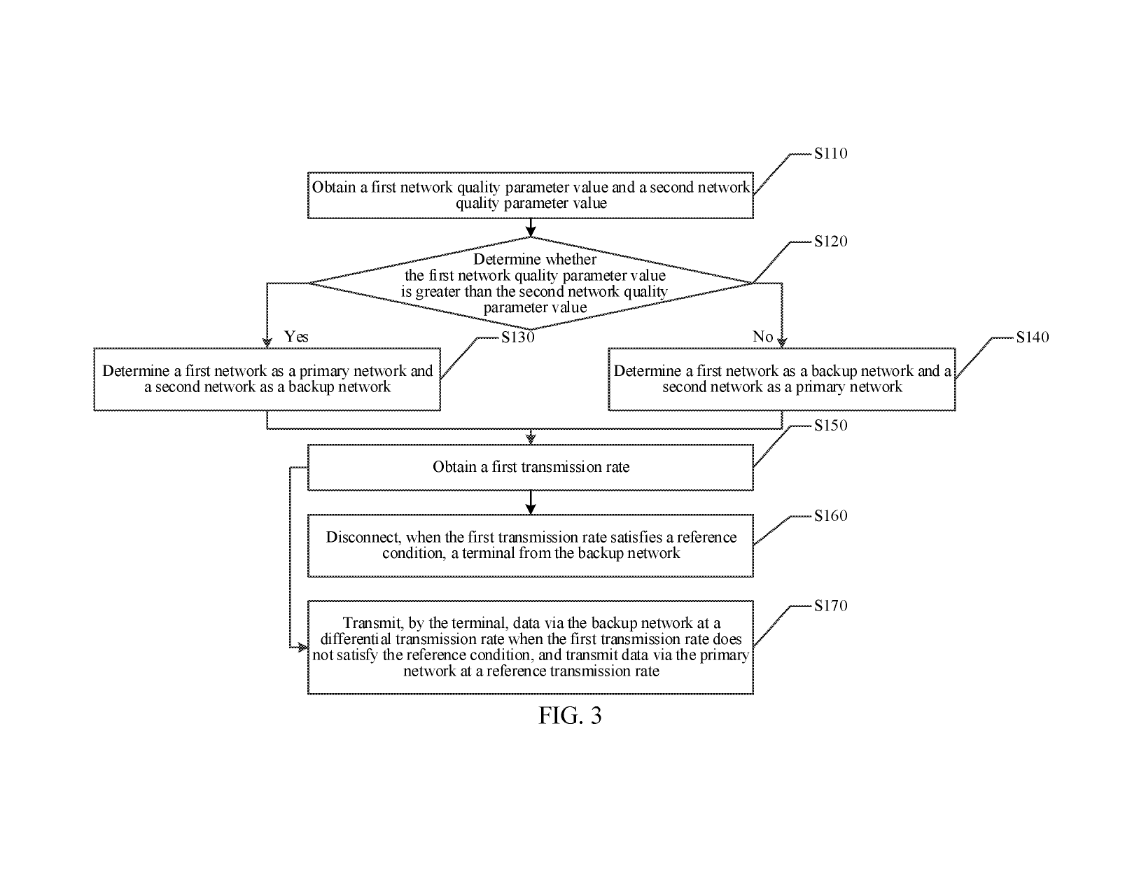

In a data transmission method of this application, after a terminal is started and accesses a first network and a second network via two USIM cards respectively, the terminal is connected to the first network via 5G, and the terminal is connected to the second network via 5G. Referring to FIG. 3, an embodiment of a data transmission method in an embodiment of this application includes:

S110: Obtain a first network quality parameter value and a second network quality parameter value.

The first network quality parameter value is obtained by measuring a first data transmission performed by a terminal via a first network, and the second network quality parameter value is obtained by measuring a second data transmission performed by the terminal via a second network. The first network herein may correspond to a first USIM card provided in the terminal, and the second network may correspond to a second USIM card provided in the terminal.

Specifically, since a 5G network has been widely deployed currently and common dual-cellular terminals are terminals of dual 5G mode, in the embodiments of this application, the terminal simultaneously activates the first network and the second network after being started, and both the first network and the second network are connected via 5G.

Based on the above scenario, a network quality parameter may include synchronization signal reference signal received power (SS-RSRP), which is a power value of a synchronization reference signal received by the terminal, specifically a linear average value of power at a receiving end bearing secondary synchronization signals in a cell downlink within a synchronization signal/PBCH block (SSB) measurement configuration period.

Furthermore, when the embodiments of this application are applied to a scenario where more than two USIM cards are provided in the terminal, a network quality parameter value corresponding to each USIM card is obtained.

Since the USIM cards in the terminal may belong to the same operator in actual use, the first network and the second network herein are only configured to distinguish different USIM cards, and are not necessarily limited to be networks of different operators. To be specific, the first network and the second network may belong to the same operator or different operators.

S120: Determine whether the first network quality parameter value is greater than the second network quality parameter value.

Furthermore, when the embodiments of this application are applied to a scenario where more than two USIM cards (operator networks) are provided in the terminal, this operation includes: selecting a network having a maximum network quality parameter value from a plurality of networks, performing an operation similar to that of the first network in operation S130 on the network having the maximum network quality parameter value, and performing an operation similar to that of the second network in operation S130 on a network other than the network having the maximum network quality parameter value. This is not limited herein.

If yes, operation S130 is performed.

If no, operation S140 is performed.

S130: Determine a first network as a primary network and a second network as a backup network.

When the first network quality parameter value is greater than the second network quality parameter value, the first network is determined as the primary network, and the second network is determined as the backup network. The primary network has a higher usage priority than the backup network. To be specific, when the terminal needs to perform data transmission, the primary network is preferentially used for data transmission, and the backup network is used for data transmission only when the primary network cannot provide a network bandwidth required for data transmission. In other words, the primary network is a network mainly responsible for performing data transmission tasks on the terminal, and the backup network is a network secondarily responsible for performing data transmission tasks on the terminal.

Furthermore, when the embodiments of this application are applied to a scenario where more than two USIM cards are provided in the terminal, this operation includes: selecting a network having a maximum network quality parameter value from a plurality of networks as a primary network, and determining a network other than the network having the maximum network quality parameter value as a backup network. This is not limited herein.

S140: Otherwise, determine a first network as a backup network and a second network as a primary network.

When the first network quality parameter value is less than or equal to the second network quality parameter value, the second network is determined as the primary network, and the first network is determined as the backup network.

S150: Obtain a first transmission rate.

In some implementation, the first transmission rate is defined as an average transmission rate of data transmission performed by the terminal via the primary network and/or the backup network within a first period. In practical applications, data transmission performed by the terminal via the primary network and/or the backup network herein may be understood as data transmission performed when the terminal simultaneously enables a network switch corresponding to the primary network (i.e., a network switch of the USIM card corresponding to the primary network) and a network switch corresponding to the backup network (i.e., a network switch of the USIM card corresponding to the backup network). In this case, the terminal performs data transmission via the primary network by default, and performs secondary data transmission via the backup network only when the primary network cannot meet data transmission requirements of a service, for example, when the primary network cannot provide the network bandwidth required for data transmission.

In some implementations, an instantaneous transmission rate of data transmission performed by the terminal via the primary network and/or the backup network within a first period is measured. For example, a data transmission amount of the terminal within each time unit (e.g., 1 ms, etc.) in the first period is obtained. Then, a ratio of the data transmission amount to a duration corresponding to the time unit is calculated to obtain the instantaneous transmission rate corresponding to the time unit. In addition, a sliding filter is configured to average the instantaneous transmission rates of the time units within the first period, to obtain an average transmission rate of the terminal within the first period.

In some embodiments, the average transmission rate of the terminal is measured by another device. This is not limited herein.

By way of example, when the terminal is simultaneously connected to all accessible networks via 5G, a first transmission rate is acquired intermittently, and a specific intermittence time is not limited herein.

The foregoing description of the method for obtaining the first transmission rate is merely an example, and the setting may be made according to specific application scenarios in practical applications. This is not limited herein.

S160: When the first transmission rate satisfies a reference condition, disconnect the terminal from the backup network.

The reference condition may be determined according to a transmission rate of data transmission performed by the terminal via the primary network. Specifically, the transmission rate of data transmission performed by the terminal via the primary network may be used as a reference transmission rate, and then a reference condition is set based on the reference transmission rate. For example, the reference condition may be set to be equal to the reference transmission rate. As another example, the reference condition may be set to fall within a reference transmission rate interval. The reference transmission rate interval may be, for example, [reference transmission rate, reference transmission rate + first floating rate], or [reference transmission rate - second floating rate, reference transmission rate + third floating rate]. The first floating rate, the second floating rate, and the third floating rate may all be set according to actual application requirements. This is not specifically limited in the embodiments of this application.

To be specific, when a channel capacity of the primary network may support current data transmission the terminal is disconnected from the backup network. The disconnection of the terminal from the backup network herein may be closing the connection between the terminal and the backup network, or temporarily interrupting the connection between the terminal and the backup network, for example, disconnecting the terminal from the backup network for a preset duration before reconnecting.

Specifically, to eliminate the impact of jitter generated during data transmission on network switching, the terminal may be disconnected from the backup network after the terminal performs data transmission via the primary network stably for a first duration.

By way of example, the disconnection of the terminal from the backup network includes switching the backup network to radio resource control idle (RRC-idle). In this state, the backup network stops transmitting data packets, such as heartbeat packets and detection packets.

By way of example, the data transmission during the first duration may mean that the instantaneous transmission rates acquired within the first duration all fall within a target interval, or first transmission rates acquired multiple times within the first duration are all less than the channel capacity of the primary network. This is not limited herein.

The foregoing description for stably performing data transmission for the first duration is merely an example, and the setting may be made according to specific application scenarios in practical applications. This is not limited herein.

In the embodiments of this application, the signal strength of networks accessible by a terminal currently is determined by obtaining a first network quality parameter value and a second network quality parameter value. The first network quality parameter value is obtained by measuring a first data transmission performed by the terminal via a first network. The second network quality parameter value is obtained by measuring a second data transmission performed by the terminal via a second network. In addition, a network having the strongest signal strength is selected as a primary network while other networks serve as backup networks. When the primary network may provide network bandwidth required for data transmission and operate stably for a first duration, the terminal is disconnected from the backup networks. In this way, normal data transmission of the terminal is guaranteed, and redundant network connections are reduced, thereby reducing power consumption of the terminal and improving the endurance of the terminal.

S170: Transmit, by the terminal, data via the backup network at a differential transmission rate when the first transmission rate does not satisfy the reference condition, and transmit data via the primary network at a reference transmission rate.

The differential transmission rate is a difference between the first transmission rate and the reference transmission rate, and the reference transmission rate is a maximum transmission rate of data transmission performed by the terminal via the primary network. When the reference condition is set to be equal to the reference transmission rate, the first transmission rate not satisfying the reference condition may mean that the first transmission rate is substantially lower than the reference transmission rate. When the reference condition is set to fall within a reference rate interval, the first transmission rate not satisfying the reference condition may mean that the first transmission rate is below the reference rate interval.

To be specific, when the channel capacity of the primary network is insufficient to support current data transmission, a multi-link scheduling solution is proposed as follows:

Data is preferentially transmitted via the primary network, and the terminal uses a target congestion algorithm configured for performing congestion control for data transmission via the primary network. The primary network is optimized by using the target congestion algorithm, so that the reference transmission rate is as close as possible to the maximum transmission rate supportable by the primary network.

When part of the data that cannot be borne by the primary network is transmitted via the backup network, the transmission rate of the backup network is defined as a difference between the first transmission rate and the reference transmission rate (differential transmission rate).

Furthermore, when the embodiments of this application are applied to a scenario where more than two USIM cards are provided in the terminal, a plurality of backup networks may jointly output the differential transmission rate.

In some possible scenarios, the differential transmission rate may be evenly allocated among the plurality of backup networks.

In some embodiments, the plurality of backup networks may be sorted according to transmission priorities based on network quality parameter values of the backup networks, and data transmission is preferentially performed using the backup network with the highest priority among the backup networks. This is not limited herein.

In the embodiments of this application, when the primary network cannot fully bear all data transmission of the terminal, the terminal retains data transmission with the backup network to ensure normal data transmission of the terminal and improve reliability of the data transmission of the terminal.

FIG. 3 illustrates the data transmission method performed by a terminal in a starting state of the terminal.

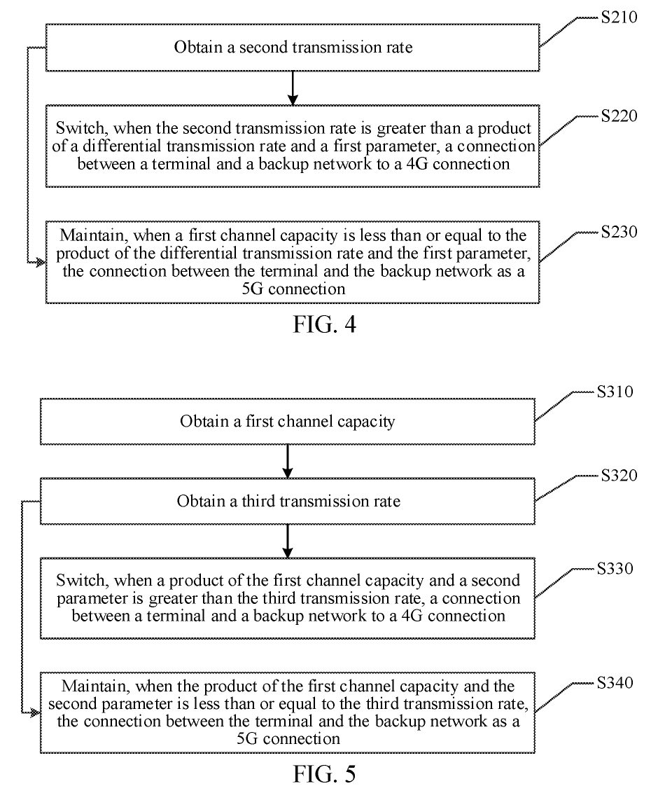

FIG. 4 illustrates a data transmission method, where the terminal is provided with at least two USIM cards, the connection between the terminal and the primary network is a 5G connection, and the connection between the terminal and the backup network is a 5G connection.

S210: Obtain a second transmission rate.

The second transmission rate is a data transmission rate of the backup network within a second period. The second transmission rate is a data transmission rate when the terminal is connected to the backup network via 5G. The second period is after the first period.

Specifically, in the solution provided by this application, the terminal accesses the same base station during switching between 4G and 5G links. Therefore, the transmission rate of the backup network may be estimated by acquiring an SS-RSRP value of the backup network and an SS-SINR value of the backup network.

In a possible implementation, a window time may be set to quickly switch the connection between the terminal and the backup network from a 5G connection to a 4G connection and then quickly switch back to the 5G connection, and the second transmission rate may be directly measured when the connection between the terminal and the backup network is in a 4G state.

The foregoing description of the method for obtaining the second transmission rate is merely an example, and the setting may be made according to specific application scenarios in practical applications. This is not limited herein.

S220: Switch, when the second transmission rate is greater than a product of a differential transmission rate and a first parameter, a connection between a terminal and a backup network to a 4G connection.

The first parameter is greater than 1, and the first parameter may be a parameter set by a technician according to actual usage requirements. For example, the first parameter is 1.5 or 2. This is not limited herein.

Specifically, when the first parameter is 1.5 and the second transmission rate is greater than the product of the differential transmission rate and the first parameter, the data transmission rate of the terminal via the backup network is much lower than a bearable transmission rate of the 4G connection of the backup network. Since power consumption of the 5G connection is 20% to 30% higher than that of the 4G connection at the same terminal, the solution provided by the embodiments of this application can timely help the terminal to switch the connection with the backup network from 5G connection to the 4G connection.

S230: Maintain, when a first channel capacity is less than or equal to the product of the differential transmission rate and the first parameter, the connection between the terminal and the backup network as a 5G connection.

In the embodiments of this application, full consideration is given to the fact that power consumption of the terminal connected to the network via 5G is higher than that via 4G. The connection between the terminal and the backup network is timely switched from 5G to 4G, thereby reducing power consumption during use of the terminal and improving the endurance of the terminal in the solution.

FIG. 5 illustrates a data transmission method provided by the embodiments of this application, where the terminal is provided with at least two USIM cards, the connection between the terminal and a target network is a 5G connection, and the connection between the terminal and the backup network is a 5G connection. This application further proposes another method for managing a backup network. The method is described below with reference to FIG. 5.

S310: Obtain a first channel capacity.

The first channel capacity is a 5G channel capacity of the backup network within a third period. The connection between the terminal and the primary network is a 5G connection in the third period, and the connection between the terminal and the backup network is a 5G connection in the third period. The third period is after the first period.

Specifically, the channel capacity of the backup network when the connection between the terminal and the backup network is a 5G connection may be estimated by acquiring an SS-RSRP value of the backup network and an SS-SINR value of the backup network.

S320: Obtain a third transmission rate.

The third transmission rate is an average transmission rate of data transmission performed by the terminal via the backup network within a third period.

S330: Switch, when a product of the first channel capacity and a second parameter is greater than the third transmission rate, a connection between a terminal and a backup network to a 4G connection.

The second parameter is less than 1 and greater than 0, and the second parameter may be a parameter set by a technician according to actual usage requirements. For example, the second parameter is 0.1. This is not limited herein.

Specifically, when the second parameter is 0.1 and the product of the first channel capacity and the second parameter is greater than the third transmission rate, the data transmission rate of the terminal via the backup network is much lower than bearable transmission data of the 5G connection of the backup network. Because power consumption of the 5G connection is 20% to 30% higher than that of the 4G connection for the same terminal, the connection between the terminal and the backup network may be timely switched to the 5G connection. This is not limited herein.

S340: Maintain, when the product of the first channel capacity and the second parameter is less than or equal to the third transmission rate, the connection between the terminal and the backup network as a 5G connection.

In the embodiments of this application, another idea of a network management method between the terminal and the backup network is provided when the terminal is connected to both the primary network and the backup network via 5G, thereby improving the flexibility of the solution.

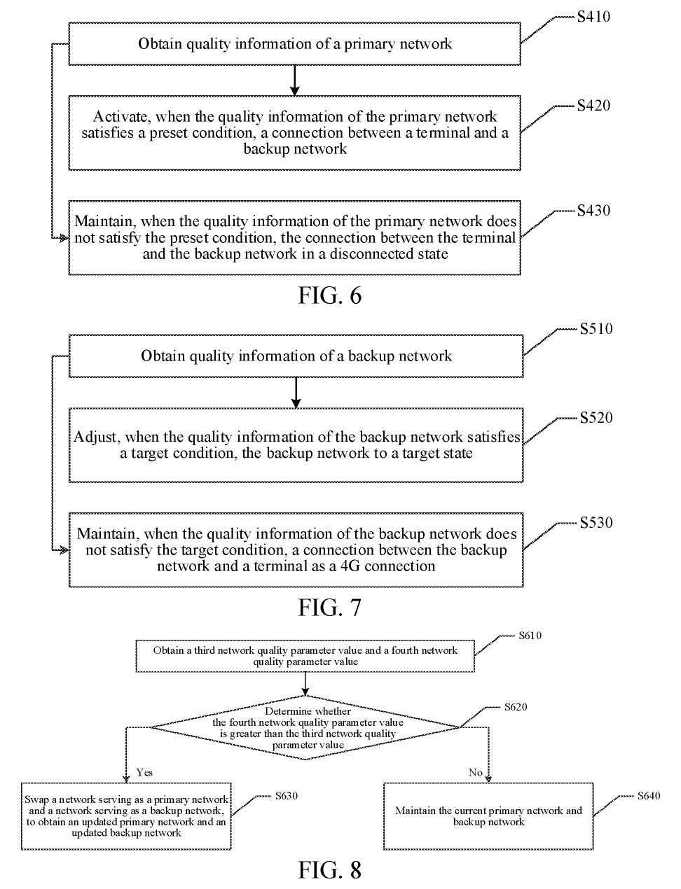

FIG. 6 illustrates a data transmission method provided by the embodiments of this application, where the terminal is provided with at least two USIM cards and the terminal is connected only to the primary network.

S410: Obtain quality information of a primary network.

The quality information of the primary network may include signal quality of the primary network, and/or a transmission rate of the primary network. This is not limited herein.

Specifically, the signal quality of the primary network may include SS-RSRP of the primary network, and/or SS-SINR of the primary network. This is not limited herein.

The foregoing description of the quality information of the primary network is merely an example, and the setting may be made according to actual conditions in practical applications. This is not limited herein.

S420: Activate, when the quality information of the primary network satisfies a preset condition, the connection between the terminal and the backup network.

In the solution provided by this application, there are different cases for activating the connection between the terminal and the backup network according to different preset conditions needing to be satisfied by the quality information of the primary network, which are analyzed respectively below.

A. The quality information of the primary network includes signal quality of the primary network, and the preset condition includes the signal quality of the primary network degrading.

By way of example, the signal quality of the primary network may be an SS-RSRP value of the primary network.

When the SS-RSRP value of the primary network decreases, it indicates that the bearer capability of the primary network is reduced. The channel capacity of the primary network is estimated according to the SS-RSRP value of the primary network or the SS-SINR value of the primary network.

If the channel capacity of the primary network is less than a product of a data transmission amount of the terminal and a third parameter, the connection between the terminal and the backup network is activated, so that the connection between the terminal and the backup network is a 4G connection.

The third parameter may be greater than 1, for example, 1.5 or 2. This is not limited herein.

Furthermore, to eliminate misjudgment caused by network jitter, the connection between the terminal and the backup network may be activated after the state that an available channel capacity of the primary network is less than the product of the data transmission amount of the terminal and the third parameter lasts for a second duration. This is not limited herein.

In the embodiments of this application, when the bearer capability of the primary network cannot meet the data transmission requirements of the terminal, the 4G connection of the backup network is preferentially activated, and then the connection between the terminal and the backup network is further switched from the 4G connection, thereby avoiding redundancy of data transmission capability caused by directly activating a 5G connection between the terminal and the backup network, and improving the flexibility of the solution.

B. The quality information of the primary network includes a transmission rate of the primary network and signal quality of the primary network, and the preset condition includes the signal quality of the primary network remaining unchanged and the transmission rate of the primary network being reduced.

By way of example, the signal quality of the primary network may be an SS-RSRP value of the primary network.

Specifically, when the SS-RSRP value of the primary network remains unchanged and the transmission rate of the primary network is reduced, such a scenario is usually a crowded scenario. In such a scenario, congestion occurs on a 4G link before congestion occurs on a 5G link. To improve the data transmission rate of the terminal more efficiently, the connection between the terminal and the backup network may be activated, where the connection between the terminal and the backup network is a 5G connection.

The scenario where the SS-RSRP value of the primary network remains unchanged and the transmission rate of the primary network is reduced may be, for example, a concert or a subway.

In the embodiments of this application, a detailed description is provided for the situation where the primary network cannot bear the data transmission of the terminal. Based on the actual situation that 4G link congestion occurs before 5G network congestion, a customized design is adopted for the scenario where the signal quality of the network is good but the transmission quality of the network deteriorates, to directly activate the connection between the terminal and the backup network and switch to the 5G connection. The flexibility of the solution is improved, and the practicability of the solution and the network stability of the terminal are also improved.

S430: Maintain, when the quality information of the primary network does not satisfy the preset condition, the connection between the terminal and the backup network in a disconnected state.

Specifically, when the SS-RSRP value of the primary network is not reduced and the transmission rate of the primary network is not reduced, it is determined that the quality information of the primary network does not satisfy the preset condition, and the connection between the terminal and the backup network is maintained in a disconnected state.

In the embodiments of this application, it is proposed that when the terminal is connected to only the primary network via a 5G network, whether to activate the connection between the terminal and the backup network may be determined according to whether the quality information of the primary network satisfies the preset condition. The connection between the terminal and the backup network may be switched flexibly according to a network connection state, thereby improving the flexibility of the solution, ensuring that the terminal in the solution may perform real-time network state switching according to requirements, and improving the reliability of data transmission of the terminal in the solution.

FIG. 7 illustrates a data transmission method provided by the embodiments of this application, where the terminal is provided with at least two USIM cards, the connection between the terminal and the primary network is a 5G connection, and the connection between the terminal and the backup network is a 4G connection.

S510: Obtain quality information of a backup network.

The quality information of the backup network includes quality information of the backup network or a transmission rate of the backup network.

Specifically, the signal quality of the backup network includes reference signal receiving power (RSRP) and signal to interference plus noise ratio (SINR) of the backup network.

The foregoing description of the quality information of the backup network is merely an example, and the setting may be made according to actual conditions in practical applications. This is not limited herein.

S520: Adjust, when the quality information of the backup network satisfies a target condition, the backup network to a target state.

In the solution provided by this application, different target states correspond to different target conditions needing to be satisfied by the quality information of the backup network, which are analyzed respectively below.

Case 1: The quality information of the backup network includes a transmission rate of the backup network, the target condition includes the transmission rate of the backup network being 0, and the target state includes no connection between the terminal and the backup network.

In a specific implementation, the transmission rate of the backup network may be directly acquired from other devices. Therefore, in the solution provided by this application, data transmission of the terminal is preferentially performed via the primary network. Therefore, when the transmission rate of the backup network is 0, the primary network may bear all data transmission of the terminal, and the connection between the terminal and the backup network is cut off (the connection between the terminal and the backup network is switched to an RRC-idle state).

Specifically, to avoid jitter caused by unstable network, when the transmission rate of the backup network remains 0 for a first duration, it is determined that the quality information of the backup network satisfies the target condition, and the connection between the terminal and the backup network is cut off (the connection between the terminal and the backup network is switched to the RRC-idle state).

Furthermore, when the embodiments of this application are applied to a scenario where more than two USIM cards (operator networks) are provided in the terminal, quality information of a plurality of backup networks may be acquired. When a transmission rate of any one backup network is 0, the connection between the terminal and the backup network is cut off. This is not limited herein.

In the embodiments of this application, since data transmission of the terminal is preferentially performed via the primary network, when the transmission rate of the backup network is 0, the primary network may bear all data transmission of the terminal. In this case, cutting off the data transmission between the terminal and the backup network can greatly save energy consumption of the terminal, and improve the endurance of the terminal while ensuring the data transmission efficiency of the terminal.

Case 2: The quality information of the backup network includes RSRP of the backup network and SINR of the backup network, the target condition includes the transmission rate of the backup network being 0, and the target state includes no connection between the terminal and the backup network.

In a specific implementation, when the acquired quality information of the backup network is the RSRP of the backup network and the SINR of the backup network,

a mapping curve between the RSRP of the backup network and an uplink rate of the backup network and a mapping curve between the SINR of the backup network and a downlink rate of the backup network may be fitted according to the acquired RSRP value of the backup network and the measured SINR value of the backup network.

Then, the transmission rate of the backup network is obtained by table lookup. This is not limited herein.

In the solution provided by this application, data transmission of the terminal is preferentially performed via the primary network. Therefore, when the transmission rate of the backup network is 0, the primary network may bear all data transmission of the terminal, and the connection between the terminal and the backup network is cut off (the connection between the terminal and the backup network is switched to an RRC-idle state).

Specifically, to avoid jitter caused by unstable network, when the transmission rate of the backup network remains 0 for a first duration, it is determined that the quality information of the backup network satisfies the target condition, and the connection between the terminal and the backup network is cut off (the connection between the terminal and the backup network is switched to the RRC-idle state).

Furthermore, when the embodiments of this application are applied to a scenario where more than two USIM cards (operator networks) are provided in the terminal, quality information of a plurality of backup networks may be acquired. When a transmission rate of any one backup network is 0, the connection between the terminal and the backup network is cut off. This is not limited herein.

Case 3: When the quality information of the backup network is signal quality of the backup network, the target condition includes the signal quality of the backup network degrading, and the target state includes the connection between the terminal and the backup network being a 5G connection.

The signal quality of the backup network is specifically received signal strength indication (RSSI) of the backup network. When the RSSI of the backup network is reduced, it indicates that the capability of the backup network to bear data transmission of the terminal is reduced, and the stability of data transmission of the terminal can be improved by switching the connection between the terminal and the backup network from a 4G connection to a 5G connection.

Furthermore, when the embodiments of this application are applied to a scenario where more than two USIM cards (operator networks) are provided in the terminal, quality information of a plurality of backup networks may be acquired. When the RSSI of any one backup network is reduced, the connection between the terminal and the backup network is switched from the 4G connection to the 5G connection. This is not limited herein.

In the embodiments of this application, when the signal quality of the backup network degrades, the data transmission between the terminal and the backup network is switched from the 4G connection to the 5G connection to maintain the stability of data transmission of the terminal, thereby improving the stability of data transmission of the terminal.

S530: Maintain, when the quality information of the backup network does not satisfy the target condition, a connection between the backup network and the terminal as a 4G connection.

When the quality information of the backup network does not fluctuate significantly, it may be determined that the quality information of the backup network does not satisfy the target condition.

In the embodiments of this application, a management solution for the connection between the terminal and the backup network is provided when the terminal is connected to the primary network via a 5G connection and to the backup network via a 4G connection, thereby improving the flexibility of the solution and ensures the stability of data transmission of the terminal.

FIG. 8 illustrates switching between the primary network and the backup network in the data transmission method provided by the embodiments of this application, where the terminal is provided with at least two USIM cards, the connection between the terminal and the primary network is a 5G connection, and the connection between the terminal and the backup network is a 5G connection.

S610: Obtain a third network quality parameter value and a fourth network quality parameter value.

The third network quality parameter value is obtained by measuring a third data transmission performed by the terminal via the primary network in a fourth period, and the fourth network quality parameter value is obtained by measuring a fourth data transmission performed by the terminal via the backup network in the fourth period. Specific obtaining manners of the third network quality parameter value and the fourth network quality parameter value are like those of the first network quality parameter value and the second network quality parameter value, and are not repeated herein.

Specifically, the network quality parameter value includes an SS-RSRP value. This is not limited herein.

The foregoing description of the network quality parameter value is merely an example, and the setting may be made according to specific application scenarios in practical applications. This is not limited herein.

S620: Determine whether the fourth network quality parameter value is greater than the third network quality parameter value.

Specifically, temporary network fluctuations may occur due to network stability issues, causing the fourth network quality parameter value to be greater than the third network quality parameter value. To avoid misjudgment caused by network fluctuations, this application proposes that the fourth network quality parameter value being greater than the third network quality parameter value may alternatively mean that the fourth network quality parameter value is greater than a sum of the third network quality parameter value and a fourth parameter.

The fourth parameter may be a hysteresis value for network fluctuations, for example, 3 db or 5db. This is not limited herein.

Furthermore, when the embodiments of this application are applied to a scenario where more than two USIM cards (operator networks) are provided in the terminal, this operation includes: selecting a network having a maximum network quality parameter value from a plurality of networks, performing an operation similar to that of the primary network in operation S630 on the network having the maximum network quality parameter value, and performing an operation similar to that of the backup network in operation S630 on a network other than the network having the maximum network quality parameter value. This is not limited herein.

If yes, operation S630 is performed.

If no, operation S640 is performed.

S630: Swap a network serving as a primary network and a network serving as a backup network, to obtain an updated primary network and an updated backup network.

By way of example, the primary network corresponds to USIM card 1, and USIM card 1 corresponds to operator network 1. The backup network corresponds to USIM card 2, and USIM card 2 corresponds to operator network 2.

When the third network quality parameter value corresponding to USIM card 1 is less than or equal to the fourth network quality parameter value corresponding to USIM card 2, USIM card 2 is taken as the updated primary network, and USIM card 1 is taken as the updated backup network. This is not limited herein.

S640: Maintain the current primary network and backup network.

When the fourth network quality parameter value is less than or equal to the third network quality parameter value, the current primary network and backup network are maintained.

In the embodiments of this application, when both the primary network and the backup network are in a 5G state, it is determined whether to switch the primary network and the backup network according to the current network conditions, to maximize the utilization of network resources, thereby improving data transmission efficiency, enabling the terminal to perform data transmission via as few network connections as possible, and optimizing power consumption of the terminal.

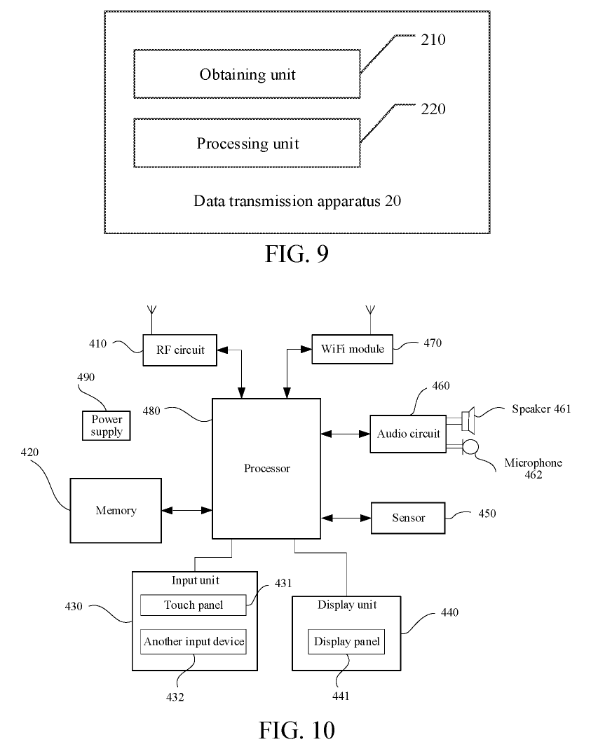

A data transmission apparatus provided in this application is described below in detail. Referring to FIG. 9, FIG. 9 is a schematic diagram of an embodiment of a data transmission apparatus according to an embodiment of this application. A data transmission apparatus 20 includes:

an obtaining unit 210, configured to obtain a first network quality parameter value and a second network quality parameter value, the first network quality parameter value being obtained by measuring a first data transmission performed by a terminal via a first network, and the second network quality parameter value being obtained by measuring a second data transmission performed by the terminal via a second network; and

a processing unit 220, configured to determine, when the first network quality parameter value is greater than the second network quality parameter value, the first network as a primary network and the second network as a backup network.

The obtaining unit 210 is further configured to obtain a first transmission rate, the first transmission rate being an average transmission rate of data transmission performed by the terminal via the primary network and/or the backup network within a first period.

The processing unit 220 is further configured to disconnect, when the first transmission rate satisfies a reference condition, the terminal from the backup network after a first duration, the reference condition being determined according to a transmission rate of data transmission performed by the terminal via the primary network.

In the embodiments of this application, the signal strength of networks accessible by a terminal currently is determined by obtaining a first network quality parameter value and a second network quality parameter value. The first network quality parameter value is obtained by measuring a first data transmission performed by the terminal via a first network. The second network quality parameter value is obtained by measuring a second data transmission performed by the terminal via a second network. In addition, a network having the strongest signal strength is selected as a primary network while other networks serve as backup networks. When the primary network may provide network bandwidth required for data transmission and operate stably for a first duration, the terminal is disconnected from the backup networks. In this way, normal data transmission of the terminal is guaranteed, and redundant network connections are reduced, thereby reducing power consumption of the terminal and improving the endurance of the terminal.

In some embodiments, the processing unit 220 is further configured to transmit, by the terminal, data via the backup network at a differential transmission rate when the first transmission rate does not satisfy the reference condition, the differential transmission rate being a difference between the first transmission rate and a reference transmission rate, and the reference transmission rate being the transmission rate of data transmission performed by the terminal via the primary network.

In the embodiments of this application, when the primary network cannot fully bear all data transmission of the terminal, data transmission between the terminal and the backup network is retained, to ensure normal data transmission of the terminal and improve reliability of the data transmission of the terminal.

In some embodiments, the connection between the terminal and the backup network is a 5G connection.

The obtaining unit 210 is further configured to obtain a second transmission rate, the second transmission rate being a transmission rate of the backup network in a second period.

The processing unit 220 is further configured to switch, when the second transmission rate is greater than a product of the differential transmission rate and a first parameter, the connection between the terminal and the backup network to a 4G connection, the first parameter being greater than 1.

In the embodiments of this application, full consideration is given to the fact that power consumption of the terminal connected to the network via 5G is higher than that via 4G. The connection between the terminal and the network is timely switched from 5G to 4G, thereby reducing power consumption during use of the terminal and improving the endurance of the terminal in the solution.

In some embodiments, the obtaining unit 210 is further configured to obtain, when the terminal is connected to the backup network and the connection between the terminal and the backup network is the 5G connection, a first channel capacity, the first channel capacity being a 5G channel capacity of the backup network in a third period.

The obtaining unit 210 is further configured to obtain a third transmission rate, the third transmission rate being an average transmission rate of data transmission performed by the terminal via the backup network within the third period.

The processing unit 220 is further configured to switch, when a product of the first channel capacity and a second parameter is greater than the third transmission rate, the connection between the terminal and the backup network to the 4G connection, the second parameter being greater than 0 and less than 1.

In the embodiments of this application, another idea of a network management method between the terminal and the backup network is provided when the terminal is connected to both the primary network and the backup network via 5G, thereby improving the flexibility of the solution.

In some embodiments, when the terminal is disconnected from the backup network, the obtaining unit 210 is further configured to obtain quality information of the primary network.

The processing unit 220 is further configured to activate, when the quality information of the primary network satisfies a preset condition, the connection between the terminal and the backup network.

In the embodiments of this application, it is proposed that when the terminal is connected to only the primary network via a 5G network, whether to activate the connection between the terminal and the backup network may be determined according to whether the quality information of the primary network satisfies the preset condition. The connection between the terminal and the backup network may be switched flexibly according to a network connection state, thereby improving the flexibility of the solution, ensuring that the terminal in the solution may perform real-time network state switching according to requirements, and improving the reliability of data transmission of the terminal in the solution.

In some embodiments, the quality information of the primary network includes signal quality of the primary network, and the preset condition includes the signal quality of the primary network degrading.

The processing unit 220 is specifically configured to activate, when the signal quality of the primary network degrades, the connection between the terminal and the backup network, the connection between the terminal and the backup network being the 4G connection.

In the embodiments of this application, when the bearer capability of the primary network cannot meet the data transmission requirements of the terminal, the 4G connection of the backup network is preferentially activated, and then the connection between the terminal and the backup network is further switched from the 4G connection, thereby avoiding redundancy of data transmission capability possibly caused by directly activating a 5G connection between the terminal and the backup network, and improving the flexibility of the solution.

In some embodiments, the quality information of the primary network includes a transmission rate of the primary network and signal quality of the primary network, and the preset condition includes the signal quality of the primary network remaining unchanged and the transmission rate of the primary network being reduced.

The processing unit 220 is specifically configured to activate, when the signal quality of the primary network remains unchanged and the transmission rate of the primary network is reduced, the connection between the terminal and the backup network, the connection between the terminal and the backup network being the 5G connection.

In the embodiments of this application, a detailed description is provided for the situation where the primary network cannot bear the data transmission of the terminal. Based on the actual situation that 4G link congestion occurs before 5G network congestion, a customized design is adopted for the scenario where the signal quality of the network is good but the transmission quality of the network deteriorates, to directly activate the connection between the terminal and the backup network and switch to the 5G connection. The flexibility of the solution is improved, and the practicability of the solution and the network stability of the terminal are also improved.

In some embodiments, the obtaining unit 210 is further configured to obtain, when the terminal is connected to the backup network and the connection between the terminal and the backup network is the 4G connection, quality information of the backup network.

The processing unit 220 is further configured to adjust, when the quality information of the backup network satisfies a target condition, the backup network to a target state.

In the embodiments of this application, a management solution for the connection between the terminal and the backup network is provided when the terminal is connected to the primary network via a 5G connection and to the backup network via a 4G connection, thereby improving the flexibility of the solution and ensures the stability of data transmission of the terminal.

In some embodiments, the quality information of the backup network includes a transmission rate of the backup network, the target state includes no connection between the terminal and the backup network, and the target condition includes the transmission rate of the backup network being 0.

The processing unit 220 is specifically configured to disconnect, when the transmission rate of the backup network is 0, the terminal from the backup network.

In the embodiments of this application, since data transmission of the terminal is preferentially performed via the primary network, when the transmission rate of the backup network is 0, the primary network may bear all data transmission of the terminal. In this case, cutting off the data transmission between the terminal and the backup network can greatly save energy consumption of the terminal, and improve the endurance of the terminal while ensuring the data transmission efficiency of the terminal.

In some embodiments, the quality information of the backup network includes signal quality of the backup network, the target state includes the connection between the terminal and the backup network being the 5G connection, and the target condition includes the signal quality of the backup network degrading.

The processing unit 220 is specifically configured to switch, when the signal quality of the backup network degrades, the connection between the terminal and the backup network to the 5G connection.

In the embodiments of this application, when the signal quality of the backup network degrades, the data transmission between the terminal and the backup network is switched from the 4G connection to the 5G connection to maintain the stability of data transmission of the terminal, thereby improving the stability of data transmission of the terminal.

In some embodiments, the obtaining unit 210 is further configured to obtain, when the terminal is connected to the backup network and the connection between the terminal and the backup network is the 5G connection, a third network quality parameter value and a fourth network quality parameter value, the third network quality parameter value being obtained by measuring a third data transmission performed by the terminal via the primary network within a fourth period, and the fourth network quality parameter value being obtained by measuring a fourth data transmission performed by the terminal via the backup network within the fourth period.

The processing unit 220 is further configured to swap, when the fourth network quality parameter value is higher than the third network quality parameter value, a network serving as the primary network and a network serving as the backup network, to obtain an updated primary network and an updated backup network.

In the embodiments of this application, when both the primary network and the backup network are in a 5G state, it is determined whether to switch the primary network and the backup network according to the current network conditions, to maximize the utilization of network resources, thereby improving data transmission efficiency, enabling the terminal to perform data transmission via as few network connections as possible, and optimizing power consumption of the terminal.

The data transmission apparatus provided in this application may be used in a terminal. Referring to FIG. 10, for ease of description, only a part related to the embodiments of this application is shown. For a specific technical detail not disclosed, refer to the method part in the embodiments of this application. In the embodiments of this application, the terminal is described by taking a smartphone as an example.

FIG. 10 is a block diagram of a structure of a part of a smartphone related to a terminal according to an embodiment of this application. Referring to FIG. 10, the smartphone includes components such as a radio frequency (RF) circuit 410, a memory 420, an input unit 430, a display unit 440, a sensor 450, an audio circuit 460, a wireless fidelity (WiFi) module 470, a processor 480, and a power supply 490. The structure of the smartphone shown in FIG. 10 does not constitute a limitation on the smartphone, and the smartphone may include more components or fewer components than those shown in the figure, or some components may be combined, or a different component deployment may be used.

The following specifically describes the components of the smartphone with reference to FIG. 10.

The RF circuit 410 may be configured to receive and transmit signals during an information receiving and transmitting process or a call process. Specifically, the RF circuit receives downlink information from a base station, then delivers the downlink information to the processor 480 for processing, and transmits designed uplink data to the base station. Generally, the RF circuit 410 includes, but is not limited to, an antenna, at least one amplifier, a transceiver, a coupler, a low noise amplifier (LNA), a duplexer, and the like. In addition, the RF circuit 410 may further communicate with a network and another device through wireless communication. The wireless communication may use any communications standard or protocol, which includes, but is not limited to, Global System for Mobile communications (GSM), General Packet Radio Service (GPRS), Code Division Multiple Access (CDMA), Wideband Code Division Multiple Access (WCDMA), Long Term Evolution (LTE), e-mail, Short Messaging Service (SMS), and the like.

The memory 420 may be configured to store a software program and module. The processor 480 runs the software program and module stored in the memory 420, to implement various functional applications and data processing of the smartphone. The memory 420 may mainly include a program storage area and a data storage area. The program storage area may store an operating system, an application program (such as a sound playing function or an image playing function) required for at least one function, etc. The data storage area may store data (such as audio data or a phone book) created based on use of the smartphone, etc. In addition, the memory 420 may include a high speed random-access memory, and may further include a non-volatile memory, such as at least one magnetic disk storage device, a flash memory, or another volatile solid storage device.

The input unit 430 may be configured to receive input digit or character information, and generate a keyboard signal input related to the user setting and function control of the smartphone. Specifically, the input unit 430 may include a touch panel 431 and another input device 432. The touch panel 431, also referred to as a touch screen, may collect a touch operation of a user on or near the touch panel (such as an operation of the user on the touch panel 431 or near the touch panel 431 by using any suitable object or accessory such as a finger or a stylus), and drive a corresponding connection apparatus according to a preset program. In some embodiments, the touch panel 431 may include two parts: a touch detection apparatus and a touch controller. The touch detection apparatus detects a touch orientation of a user and a signal generated by a touch operation, and transmits the signal to the touch controller. The touch controller receives touch information from the touch detection apparatus, converts the touch information into touch point coordinates, transmits the touch point coordinates to the processor 480, and can receive and execute a command transmitted by the processor 480. In addition, the touch panel 431 may be implemented by using various types, such as a resistive type, a capacitive type, an infrared type, and a surface acoustic wave type. In addition to the touch panel 431, the input unit 430 may further include the another input device 432. Specifically, the another input device 432 may include, but is not limited to, one or more of a physical keyboard, a functional key (such as a volume control key or a switch key), a track ball, a mouse, and a joystick.

The display unit 440 may be configured to display information input by the user or information provided for the user, and various menus of the smartphone. The display unit 440 may include a display panel 441. In some embodiments, the display panel 441 may be configured by using a liquid crystal display (LCD), an organic light-emitting diode (OLED), or the like. Further, the touch panel 431 may cover the display panel 441. After detecting a touch operation on or near the touch panel, the touch panel 431 transfers the touch operation to the processor 480, to determine a type of a touch event. Then, the processor 480 provides a corresponding visual output on the display panel 441 according to the type of the touch event. Although in FIG. 10, the touch panel 431 and the display panel 441 are used as two independent parts, to implement input and output functions of the smartphone, in some embodiments, the touch panel 431 and the display panel 441 may be integrated to implement the input and output functions of the smartphone.

The smartphone may further include at least one sensor 450 such as an optical sensor, a motion sensor, and other sensors. Specifically, the optical sensor may include an ambient light sensor and a proximity sensor. The ambient light sensor may adjust luminance of the display panel 441 according to brightness of the ambient light. The proximity sensor may switch off the display panel 441 and/or backlight when the smartphone is moved to the ear. As one type of motion sensor, an acceleration sensor can detect magnitude of accelerations in various directions (generally on three axes), may detect magnitude and a direction of the gravity when being static, and may be applied to an application that recognizes the attitude of the smartphone (for example, switching between landscape orientation and portrait orientation, a related game, and magnetometer attitude calibration), a function related to vibration recognition (such as a pedometer and a knock), and the like. Other sensors, such as a gyroscope, a barometer, a hygrometer, a thermometer, and an infrared sensor, which may be configured in the smartphone, are not further described herein.

The audio circuit 460, a speaker 461, and a microphone 462 may provide audio interfaces between the user and the smartphone. The audio circuit 460 may transmit an electrical signal converted from received audio data to the speaker 461, and the speaker 461 converts the electrical signal into a sound signal for output. In addition, the microphone 462 converts a collected sound signal into an electrical signal. After receiving the electrical signal, the audio circuit 460 converts the electrical signal into audio data, and then outputs the audio data. After processed by the processor 480, the audio data is transmitted through the RF circuit 410 to, for example, another smartphone or the audio data is outputted to the memory 420 for further processing.

WiFi belongs to a short distance wireless transmission technology. The smartphone may help, by using the WiFi module 470, a user to receive and send an email, browse a web page, access stream media, and the like. This provides wireless broadband Internet access for the user. Although FIG. 10 shows the WiFi module 470, the WiFi module is not a necessary component of the smartphone, and when required, the WiFi module may be omitted if the scope of the essence of the present disclosure is not changed.

The processor 480 is a control center of the smartphone, and is connected to various parts of the entire smartphone by using various interfaces and lines. By running or executing the software program and/or the module stored in the memory 420, and invoking data stored in the memory 420, the processor executes various functions of the smartphone and performs data processing, thereby monitoring the entire smartphone. In some embodiments, the processor 480 may include one or more processing units. Preferably, the processor 480 may integrate an application processor and a modem processor, where the application processor mainly handles an operating system, a user interface, application programs, etc., and the modem processor mainly handles wireless communication. The modem processor may not be integrated into the processor 480.

The smartphone further includes the power supply 490 (such as a battery) for supplying power to the components. In some embodiments, the power supply may be logically connected to the processor 480 by using a power management system, thereby implementing functions such as charging, discharging and power consumption management by using the power management system.

Although not shown in the figure, the smartphone may further include a camera, a Bluetooth module, and the like. Details are not described herein again.

The operations performed by the terminal in the foregoing embodiments may be based on the structure of the terminal shown in FIG. 10.

An embodiment of this application further provides a computer-readable storage medium, storing a computer program, the computer program, when run on a computer, causing the computer to perform the method described in the foregoing embodiments.

An embodiment of this application further provides a computer program product including a program. The program, when run on a computer, causes the computer to perform the method described in the foregoing embodiments.

For convenience and conciseness of description, for specific working processes of the foregoing systems, devices, and units, refer to the corresponding processes in the foregoing method embodiments. Details are not described herein again.

In the several embodiments provided in this application, the disclosed system, apparatus, and method may be implemented in other manners. For example, the apparatus embodiment described above is merely an example. For example, the unit division is merely a logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be in one place or may be distributed over a plurality of network units. Some or all of the units may be selected according to actual needs to achieve the objectives of the solutions of the embodiments.

In addition, functional units in the embodiments of this application may be integrated into one processing unit, or each of the units may be physically separated, or two or more units may be integrated into one unit. The integrated unit may be implemented in the form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the related technology, or all or some of the technical solutions may be implemented in the form of a software product. The computer software product is stored in a storage medium and includes several instructions for instructing a computer device (which may be a personal computer, a server, a network device, or the like) to perform all or some of the operations of the methods described in the embodiments of this application. The foregoing storage medium includes: any medium that may store program code, such as a USB flash drive, a removable hard disk, a read-only memory (ROM), a random access memory (RAM), a magnetic disk, or an optical disc.

The foregoing embodiments are merely intended for describing the technical solutions of this application, but not for limiting this application. Although this application is described in detail with reference to the foregoing embodiments, the technical solutions described in the foregoing embodiments may be modified or some technical features thereof may be equivalently replaced. Such modifications or replacements do not cause the essence of the corresponding technical solutions to depart from the spirit and scope of the technical solutions of the embodiments of this application.

What is claimed is:

1. A data transmission method performed by a computer device acting as a terminal, the method comprising:
obtaining, by the terminal, a first network quality parameter value of a first network and a second network quality parameter value of a second network;
when the first network quality parameter value is greater than the second network quality parameter value, determining, by the terminal, the first network as a primary network and the second network as a backup network;
obtaining, by the terminal, a first transmission rate, the first transmission rate being an average transmission rate of data transmission performed by the terminal via the primary network within a first period; and
when the first transmission rate satisfies a reference condition, disconnecting, by the terminal, from the backup network after a first duration.

2. The method according to claim 1, the method further comprising:
when the first transmission rate does not satisfy the reference condition, transmitting, by the terminal, data via the backup network at a differential transmission rate, wherein the differential transmission rate is a difference between the first transmission rate and a reference transmission rate, and the reference transmission rate being a maximum transmission rate of data transmission performed by the terminal via the primary network.

3. The method according to claim 2, wherein the connection between the terminal and the backup network is a 5G connection, and the method further comprises:
obtaining a second transmission rate of the backup network within a second period; and
when the second transmission rate is greater than the differential transmission rate, switching the connection between the terminal and the backup network from the 5G connection to a 4G connection.

4. The method according to claim 2, wherein the connection between the terminal and the backup network is a 5G connection, and the method further comprises:
obtaining a first channel capacity of the backup network within a third period;
obtaining a third transmission rate, the third transmission rate being an average transmission rate of data transmission performed by the terminal via the backup network within the third period; and
when the first channel capacity is greater than the third transmission rate, switching the connection between the terminal and the backup network from the 5G connection to a 4G connection.

5. The method according to claim 1, wherein after the terminal is disconnected from the backup network, the method further comprises:
obtaining quality information of the primary network; and
when the quality information of the primary network indicates that signal quality of the primary network degrades to a preset level or a transmission rate of the primary network reduces to a preset value, reactivating the connection between the terminal and the backup network.

6. The method according to claim 1, the method further comprising:
after the terminal is connected to the backup network via a 4G connection, obtaining quality information of the backup network; and
when the quality information of the backup network indicates that a transmission rate of the backup network is zero, disconnecting the terminal with the backup network.

7. The method according to claim 1, wherein the connection between the terminal and the backup network is a 5G connection, and the method further comprises:
obtaining a third network quality parameter value and a fourth network quality parameter value, the third network quality parameter value being obtained by measuring a third data transmission via the primary network within a fourth period, and the fourth network quality parameter value being obtained by measuring a fourth data transmission via the backup network within the fourth period; and
when the fourth network quality parameter value is higher than the third network quality parameter value, swapping the primary network and the backup network, to obtain an updated primary network and an updated backup network.

8. The method according to claim 1, wherein the first network quality parameter value is obtained by measuring a first data transmission via the first network, and the second network quality parameter value is obtained by measuring a second data transmission performed by the terminal via the second network.

9. The method according to claim 1, wherein the first duration is longer than the first period.

10. A computer device acting as a terminal, comprising a memory, a processor, and a bus system,
the memory being configured to store a program;
the bus system being configured to connect the memory and the processor, to cause the memory to communicate with the processor; and
the processor being configured to execute the program in the memory and perform a data transmission method based on instructions in program code, the method including:
obtaining, by the terminal, a first network quality parameter value of a first network and a second network quality parameter value of a second network;
when the first network quality parameter value is greater than the second network quality parameter value, determining, by the terminal, the first network as a primary network and the second network as a backup network;
obtaining, by the terminal, a first transmission rate, the first transmission rate being an average transmission rate of data transmission performed by the terminal via the primary network within a first period; and
when the first transmission rate satisfies a reference condition, disconnecting, by the terminal, from the backup network after a first duration.

11. The computer device according to claim 10, wherein the method further comprises:
when the first transmission rate does not satisfy the reference condition, transmitting, by the terminal, data via the backup network at a differential transmission rate, wherein the differential transmission rate is a difference between the first transmission rate and a reference transmission rate, and the reference transmission rate being a maximum transmission rate of data transmission performed by the terminal via the primary network.

12. The computer device according to claim 11, wherein the connection between the terminal and the backup network is a 5G connection, and the method further comprises:
obtaining a second transmission rate of the backup network within a second period; and
when the second transmission rate is greater than the differential transmission rate, switching the connection between the terminal and the backup network from the 5G connection to a 4G connection.

13. The computer device according to claim 11, wherein the connection between the terminal and the backup network is a 5G connection, and the method further comprises:
obtaining a first channel capacity of the backup network within a third period;
obtaining a third transmission rate, the third transmission rate being an average transmission rate of data transmission performed by the terminal via the backup network within the third period; and
when the first channel capacity is greater than the third transmission rate, switching the connection between the terminal and the backup network from the 5G connection to a 4G connection.

14. The computer device according to claim 10, wherein after the terminal is disconnected from the backup network, the method further comprises:
obtaining quality information of the primary network; and
when the quality information of the primary network indicates that signal quality of the primary network degrades to a preset level or a transmission rate of the primary network reduces to a preset value, reactivating the connection between the terminal and the backup network.

15. The computer device according to claim 10, wherein the method further comprises:
after the terminal is connected to the backup network via a 4G connection, obtaining quality information of the backup network; and
when the quality information of the backup network indicates that a transmission rate of the backup network is zero, disconnecting the terminal with the backup network.

16. The computer device according to claim 10, wherein the connection between the terminal and the backup network is a 5G connection, and the method further comprises:
obtaining a third network quality parameter value and a fourth network quality parameter value, the third network quality parameter value being obtained by measuring a third data transmission via the primary network within a fourth period, and the fourth network quality parameter value being obtained by measuring a fourth data transmission via the backup network within the fourth period; and
when the fourth network quality parameter value is higher than the third network quality parameter value, swapping the primary network and the backup network, to obtain an updated primary network and an updated backup network.

17. The computer device according to claim 10, wherein the first network quality parameter value is obtained by measuring a first data transmission via the first network, and the second network quality parameter value is obtained by measuring a second data transmission performed by the terminal via the second network.

18. The computer device according to claim 10, wherein the first duration is longer than the first period.

19. A non-transitory computer-readable storage medium, comprising instructions that, when executed by a processor of a computer device acting as a terminal, causing the terminal to perform a data transmission method including:
obtaining, by the terminal, a first network quality parameter value of a first network and a second network quality parameter value of a second network;
when the first network quality parameter value is greater than the second network quality parameter value, determining, by the terminal, the first network as a primary network and the second network as a backup network;
obtaining, by the terminal, a first transmission rate, the first transmission rate being an average transmission rate of data transmission performed by the terminal via the primary network within a first period; and
when the first transmission rate satisfies a reference condition, disconnecting, by the terminal, from the backup network after a first duration.

20. The non-transitory computer-readable storage medium according to claim 19, wherein the method further comprises:
when the first transmission rate does not satisfy the reference condition, transmitting, by the terminal, data via the backup network at a differential transmission rate, wherein the differential transmission rate is a difference between the first transmission rate and a reference transmission rate, and the reference transmission rate being a maximum transmission rate of data transmission performed by the terminal via the primary network.
